(19) United States
(12) Patent Application Publication
(10) Pub. No.: US 2007/0083411 A1
(43) Pub. Date: Apr. 12, 2007

(54) Schedule coordinates method for project scheduling

(76) Inventor: Yosef Alberton, Petah-Tikva (IL)

Correspondence Address: Alberton Yosef, Yehuda Hanassi, st 33/3, Petah Tikva, 49743, IL

(21) Appl. No.: 11/089,376

(22) Filed: Mar. 25, 2005

(51) Int. Cl. G06F 17/60

(52) U.S. Cl. 705/8

(57) ABSTRACT

A method is provided for generating feasible schedule for project consisting of related tasks. Project may contain tasks with given duration and tasks with given volume. Splitting may be allowed for some of tasks with given duration. Constraints are given that may include resource constraints. Method uses schedule coordinates for representing states of tasks executing and splitting. Method comprises schedule vectors generating. The constraints are checked when the schedule vectors are being generated. Effectiveness criteria may be used for decreasing number of schedule vectors and, consequently, of amount of calculations.

### CROSS_REFERENCE TO RELATED APPLICATIONS

U.S. patent application Ser. No. 11/010,919, date: Dec. 14, 2004, author: Alberton Yosef Definition of “schedule coordinate” in current invention is different: it is combination of states of chains. Definition of a coordinate reference construction in current invention is different: it contains combinations of coordinates in the new meaning. Definition of “schedule vector” in current invention is different: it is set of schedule coordinates in the new meaning.

### BACKGROUND OF THE INVENTION

Invented method may be used in common project management systems or in specialized systems for projects including resource constraints. Main limitation of method is that project is supposed to be covered with not big number of chains of tasks. Examples of projects that comply with this requirement: project, consisting of several simple subprojects; dealing with several big objects: ships, aircrafts, satellites and so on.

There are simple and powerful methods for scheduling without resource constraints: Program Evaluation and Review Technique/Critical Path Method (PERT/CPM). But for the projects with resource constraints existence of such easy and effective methods seems impossible because of the known mathematical NP-completeness results.

Some species of the invented method guarantee for resulting schedule to be optimal (shortest) for types of projects that are common enough. I do not know working project management system that automatically builds schedules for projects with resource constraints and guarantees them to be optimal.

### BRIEF SUMMARY OF THE INVENTION

An object of the present invention is a method that provides a feasible (in some cases optimal) schedule for a project, consists of related tasks with given durations or volumes. Variety of constrains may be taken in account by the invented method, including different types of resource constraints. A project is supposed to be covered with not big number of chains of tasks. The invented method is more efficient for the projects that do not contain tasks with given volume.

The method belongs to the group of dynamic programming methods. The idea is examining independent continuations of schedule fragments in separate chains or groups of chains. This goal is achieved by introducing two terms: “schedule vectors” that are sets of “schedule coordinates”. The number and the size of possible schedule vectors are essentially smaller than of possible schedule fragments, so processed information is reduced. The term “schedule vector” can be explained in a simple way: take a Gantt diagram, take a scissors and cut it into separate periods. Every strip is a prototype of schedule vector. In fact, all possible schedules are checked (if rough effectiveness criteria are not used), but only schedule vectors are saved. In the article “Alberton Y. B. “Polynomial time algorithms for scheduling problems on the “narrow networks“ ” Proceedings of the Academy of Sciences of USSR, Technical Cybernetics, 1986, #6, p. 161-171 term “state” is defined (p. 168) similar to current term “schedule vector”. The difference is that “state” from article is limited by schedule events—tasks start and finish instead of period borders in current invention.

3 species of the method are proposed: “straight” (schedule project from a start date), “opposite” (schedule project from a finish date), and “bi-directional” (combination of the straight and the opposite species.). The first step in said “straight” species is making a list of “candidate schedule vectors” for the start period. The schedule vectors that do not comply with given constraints are eliminated from the list. The second step is making a list of “candidate schedule vectors” for the second period. This list contains “children” of the schedule vectors that remain in the list of the first step. And so on. “Opposite” species is analogous.

Amount of a calculation may be reduced (and size of solved projects increased) by using effectiveness criteria. Some schedule vectors are classified by said criteria as unnecessary and may be eliminated.

Predicted maximal size of the projects that may be scheduled using the invented method is: 6-10 chains of tasks, 10-20 tasks in a chain, 100-200 periods—duration of the resulting schedule.

### BRIEF DESCRIPTION OF THE SEVERAL VIEWS OF THE DRAWINGS

FIG. 1 is a flowchart of the straight species of the invented method. It also corresponds to the opposite species.

FIG. 2 is a flowchart of bi-directional species of invented method. References with prefix “220.” refer to the flowchart in FIG. 3.

FIG. 3 is a detailed flowchart of searching for meeting schedule vectors using divide-and-conquer searching method (block 220).

FIG. 4 is a detailed flowchart of computing effectiveness criteria and eliminating unnecessary schedule vectors using divide-and-conquer eliminating method (optional part of block 126 in FIG. 1).

FIG. 5 is an example project. The tasks are represented as nodes, precedence relationships—as arrows.

FIG. 6 is a fragment of a schedule of the project from FIG. 5.

FIG. 7 is the schedule fragment from the FIG. 6 cut into schedule vectors.

FIG. 8 is an example of dividing an instance of problem into sub instances.

### DETAILED DESCRIPTION OF THE INVENTION

The present invention is a method of scheduling a project consisting of related tasks; tasks may be of two types: the tasks with given duration and the tasks with given volume; splitting may be allowed for some of the tasks with given duration; different types of the constraints may be given, including different types of resource constraints. Task with given volume is a task for which volume of parts being executed in different periods may be different and is a subject for calculation. The word “schedule” always means schedule of said project.

The chains of tasks are chosen that cover project tasks. They are called: chain 1, chain 2, . . . If said chains are not given, they may be find using the known method of Fulkerson. The word “chain” always means one of said chains.

The invented method is more efficient for the project that does not contain tasks with given volume.

The main idea that distinguishes the present invention is examining independent continuations of schedule fragments in separate chains or groups of chains. This goal is achieved by introducing two terms: “schedule vectors” that are sets of “schedule coordinates”. The number and the size of possible schedule vectors are essentially smaller than of possible schedule fragments. Such approach simplifies and reduces processed information.

Some combinations of the disclosed elements guarantee for the resulting schedule to be optimal (shortest) for the project types that are common enough.

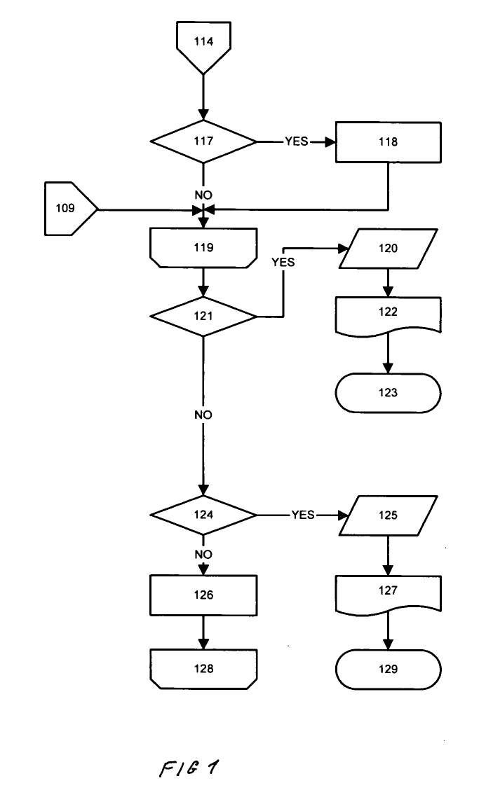

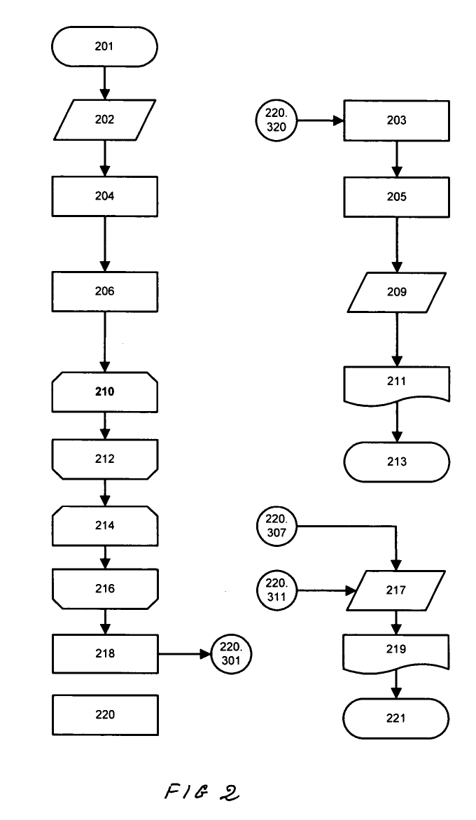

3 species of the method are proposed: “straight” (FIG. 1), “opposite” (FIG. 1), and “bi-directional” (FIG. 2).

The disclosed method contains groups of alternative elements, optional elements, and references to external methods. Specific combination of disclosed elements may be chosen by the developer or by the user. Said combination depends on the project constraints, used equipment and so on. These facts make impossible to give best way for carrying out the invention for all possible cases.

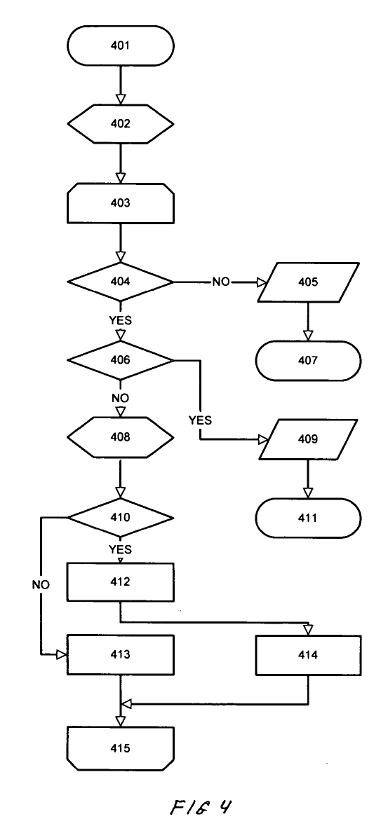

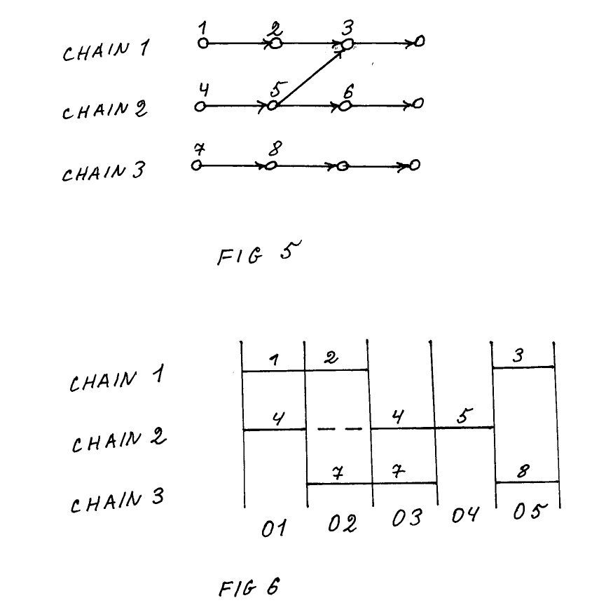

FIG. 5 is an example project. 3 chosen covered chains are indicated in the drawing. All tasks in the project are the tasks with given duration. The tasks 1, 2, 3 belong to the chain 1, the tasks 4, 5, 6- to the chain 2, the tasks 7, 8- to the chain 3. For the task 4 splitting is allowed, for the rest of the tasks splitting is forbidden. The tasks 1, 5, 6, 7, 8 use resource 1; the tasks 2, 3, 4 use resource 2. Available level of each resource is 1 in all periods. Tasks 1, 2, 3, 5, 6, 8 are 1 period long, tasks 4, 7 are 2 periods long. FIG. 6 is fragment of the possible schedule for the project. Numbers of the tasks are written above the tasks. 01-05 are the numbers of periods. A period is called “idle in a chain” if no task of said chain is executed in said period (example—period 02 is idle in chain 2). A dotted line represents an idle period inside a split task. Only working periods are considerate. “Next period”, “previous period”, “adjacent periods” implies “working”. A schedule starts on the left.

Start of definitions. “State of a chain” in some period in some schedule is: “what happens in said chain in said schedule in said period”. “Schedule coordinates” are collections of information related with (also term “assigned to” is used) combinations of states of the chosen chains. Every combination consists of one or many states of the chosen chains. Method of establishing said relationship is called “method of assigning schedule coordinates”. End of the definitions. Examples of states of chains (all examples are for the schedule in FIG. 6): the period 02 in the chain 2 is idle after execution of one-period-long initial part of task 4; last one-period-long initial part of the task 7 is executed in the chain 3 in the period 03; the period 04 is idle after completing of the task 2 in the chain 1. Terminology: “coordinate” below always means “schedule coordinate”; coordinate “represents” the states of chains included in related combination; set of coordinates “represents” a state of a chain, if said state is represented by one of the coordinates of said set. Different methods of assigning schedule coordinates may be combined.

Start of a definition. A method of assigning schedule coordinates is called a “sequential ascending method”, if: 1. All combinations that participate in said relationship are single states of the chains; said chains do not contain the tasks with given volume; 2. Coordinates are numbers. 3. If there are 2 coordinates that represent states of the same chain, then the lager coordinate corresponds to the same or more advanced state of said chain. End of the definition. “Sequential descending method” is defined analogically. Common name for both said methods is “sequential method of assigning schedule coordinates”. Term “i-coordinate” stands for “schedule coordinate assigned to the combination that consists of the single state of the chain i”.

Here is a sequential ascending method that is used in current demonstration. The coordinate that is assigned to a state of a chain in some period is calculated by the formula a+b+c+d where (all mentioned tasks belong to said chain): a is the duration of the part of the task executed in said period (if exists); b is the total duration of all the tasks completed before said period and the part of the uncompleted task (if exists) being executed before said period; c is calculated in the same way as b, but only tasks with splitting allowed are taken; d is the number of the tasks with splitting forbidden that are completed before said period. Here are examples of coordinates in period 02 in schedule in FIG. 6. They are computed by said formula. 1-coordinate=1+1+0+1=3; 2-coordinate=0+1+1+0=2; 3-coordinate=1+0+0+0=1.

FIG. 1 is a flowchart of a “straight” species. 101 is a starting point of the flowchart. 102 is data input. Data may be obtained from outer system, or another system, or from manual input.

103 is generating a “coordinate reference construction”. Start of a definition. “Coordinate reference construction” is the construction that is used for: obtaining the data corresponding to the combinations of coordinates or obtaining the data corresponding to the pairs: (combination of coordinates, period number). Every combination consists of one or many coordinates. End of the definition.

103 may be implemented in the following way: calculating coordinates, calculating corresponding data, and storing results in tables. Here are examples of data that may be obtained using a coordinate reference construction (FIG. 6). “Idle period in split task 4 after executing the initial one-period-long part of said task” corresponds to the value 2 of 2-coordinate. An indication “there is enough resources” corresponds to the combination: 1-coordinate=3, 2-coordinate=2, 3-coordinate=1. If resource 1 is not available in the period 02, then an indication “there is not enough resources” corresponds to pair: (said combination of coordinates, period 02). In block 103 also common preparations may be made.

Generating a task reference construction (104) is optional. Start of a definition. “Task reference construction” is a construction that is used for: obtaining the data corresponding to the combinations of elements or pairs: (one of said combinations, period number); every of said combinations contains no more than one element of every of chosen chains; element of a chain is the task belongs to said chain or idle periods in said chain. End of the definition.

Task reference construction may be built as table(s). Here are examples of data that may be obtained using a task reference construction for the example project. An indication “combination is incompatible” corresponds to the combination of: an idle period after the task 3 in chain 1; executing the task 4; an idle period before the task 7 in the chain 3. Said combination is incompatible because task 4 precedes to the tasks 3 in the project, so task 3 can not be finished earlier than the task 4. If the resource 1 is not available in the period 03, then an indication “not enough resources” corresponds to the combination of: an idle period after the task 2 in the chain 1, task 4, task 7, and period 03.

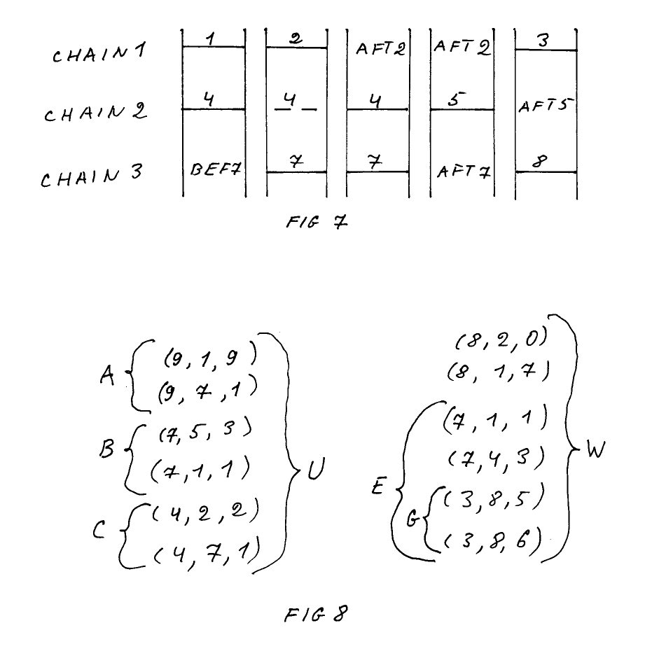

The outer loop 105-128 is the step of generating, checking and eliminating “schedule vectors”. The first iteration of the loop corresponds to the first (start) period of a schedule. The second iteration corresponds to the second period of schedule, and so on. Start of a definition. If the set of schedule coordinates represents no more than one state of each of the chosen chains, then said set is called “schedule vector”. End of the definition. If all states represented by a schedule vector belong to the same period in some known or unknown schedule, then we say that said schedule vector is related to said period in said schedule. In our example schedule vectors are n-dimensional vectors: (1-coordinate, 2-coordinate . . . n-coordinate), where n is the number of the chosen chains. Examples: schedule vectors in FIG. 7 are (from left to right): (1, 1, 0), (3, 2, 1), (4, 3, 2), (4, 5, 3), (5, 6, 4). “Aft” and “bef” stands for “after” and “before”. If some schedule vectors S and R are related to the adjacent periods in some feasible schedule of said project and S is on the left of R, then S is named “predecessor” of R and R is named “successor” of S. If some schedule vector S is generated as successor or predecessor of some previously generated schedule vector R, then R is called “parent”, S—“child”. In the straight species of invented method every child is successor of its parent. In the opposite species every child is predecessor of its parent. Note. Do not confuse term “i-coordinate” ([0030], [0031]) with “i-th component”. i-th component is common term and means i-th part of any vector.

106 is generating a list of candidate schedule vectors for the current iteration of outer loop (current period). 107-119 is a loop on said list. For the second and the next iterations, schedule vectors in said list are the children (successors) of the schedule vectors remaining in the list of the previous iteration.

If schedule vector may be implemented in some period in some feasible schedule, then it is named “compatible schedule vector”, otherwise—“incompatible schedule vector”. 108 is a block of compatibility checking of the current schedule vector. Said reference constructions may be used in 108. Compatibility checking implies resources checking. 110 is the question: “Is the current schedule vector incompatible?” 109 is eliminating the current schedule vector from the list. Elimination is any action that excludes the schedule vector from further serving as a parent in generating process or from being a part of the result schedule.

112 is the question: “Is the current schedule vector final?” Start of definitions. If S is the schedule vector generated in the straight species of invented method, then “left S-fragment” consists of: schedule vector S, parent of S, parent of parent of S, and so on, up to the schedule vector that is candidate for the first period inclusive. S is called “final schedule vector”, if left S-fragment is a feasible schedule. End of the definitions. Usually there is possibility to check without building left fragment, if some generated schedule vector is final. 111 is building the resulting schedule. 116 is a “good end”. 113 and 115 are the resulting schedule and statistics in machine readable and man readable forms.

114 is computing “effectiveness criteria” for the current schedule vector. This step is optional. Start of a definition. “Effectiveness criterion” is a method classifying some of schedule vectors as unnecessary. A schedule vector S is unnecessary for building feasible (optimal) schedule, if exists feasible (optimal) schedule that does not include said S. End of the definition. Rough (based on the not proved estimations) criteria may be used. 117 is the question: “Is the current schedule vector unnecessary?” 118 is eliminating the current schedule vector from the current list.

121 is the question: “Are the computational limitations (time, memory and so on) met?” 123 is a “bad end”. Appropriate message and statistics are provided in the machine readable (120) and man readable (122) forms.

124 is the question: “Is it true that the current list of candidate schedule vectors does not allow building feasible schedule?” Possible reasons: due date is reached, but the current list does not contain a final schedule vector; the current list is empty, because all schedule vectors are eliminated. 129 is a “bad end”. 125 and 127 are the answer and statistics in machine readable and man readable forms. If method is simplified by elements leading to a non optimal schedule, like rough effectiveness criteria, then message “Feasible schedule does not found” is provided. Otherwise message is “Feasible schedule does not exist”. 124 may be skipped, if it is proved that answer “yes” is impossible.

New terms are introduced here. If K and L are the vectors of the same dimension and each component of K is no less than the correspondent component of L, then we say that the vector K is “no less” than the vector L, and the vector L is “no grater” than the vector K. Said K and L are called “comparable vectors”. Suppose H is some set of the vectors of the same dimension and S is some vector belonging to H. If in H exists another vector that is no less than S, then S is called a “minor” vector in H. If in H exists another vector that is no grater than S, then S is called a “major” vector in H. The same vector may be “minor” and “major” in H.

126 is computing effectiveness criteria and eliminating unnecessary schedule vectors including comparing of two or more generated schedule vectors (a). This step is optional. Example of effectiveness criteria of said type is: from two equivalent generated schedule vectors one is unnecessary (two schedule vectors are called “equivalent” if they represent the same states of the chains).

Here are replacements that transform the explanation of the flowchart in FIG. 1 into the explanation of opposite species. [0037]: “first (start) period” by “last period”; second period” by “period previous to the last”. [0038]: “successors” by predecessor”. [0040]: “final” by “initial”; “first” by “last”; “left” by “right”; “straight” by “opposite”; [0043]: “due date” by start date”; “final” by “initial”.

Bi-directional species combines two processes: straight and opposite, correspondent to the straight and opposite species. Schedule is build from the given or predicted start and finish dates in the opposite directions. 201, 202, 204 and 206 are analogous to 101, 102, 103, and 104, respectively. Step of generating, checking and eliminating schedule vectors consists of 2 loops: 210-212 (a straight process) and 214-216 (an opposite process). Loop 210-212 is analogous to the loop 105-128 for straight species. Differences are: a final vector is not searched for, and a resulting schedule is not built (the blocks 112, 111, 113, 115, and 116 are excluded). In the same way, loop 214-216 is analogous to the loop 105-128 for opposite species. Total number of iterations of two said loops is equal to the duration of the schedule (according to said start and the finish dates). 221 is a bad end, accompanied by statistics and appropriate message (217—machine readable, 219—man readable form). If interval between said start and finish dates is too short, scheduling may be repeated with new values of start or finish dates. In some cases scheduling process may be continued using information generated at the previous attempt. It depends on the type of constraints.

Blocks 218 and 220 implement searching for a pair of “meeting schedule vectors”. Start of a definition. Schedule vectors S built by the straight process and R built by the opposite process are called “meeting schedule vectors”, if left S-fragment and right R-fragment cover together executing of all tasks of project. End of the definition.

220.320 is the case, when some pair S, R of meeting schedule vectors is found. S is built by the straight process; R is built by the opposite process. 203 is building an “intermediate schedule”: it is the union of the left S-fragment and right R-fragment. 205 is eliminating duplicate executing parts of tasks. 213 is a “good end”. 209 and 211 are the resulting schedule and statistics in machine readable and man readable forms. Implementation of duplicates eliminating:

if one of said fragments, suppose left S-fragment, contains executing a whole task T, and right R-fragment contains executing a part(s) of T or whole task T, and T belongs to the chain C, then: all the tasks and parts of uncompleted tasks that are executed on the right side of T in the chain C in the left S-fragment are eliminated; all the tasks and parts of uncompleted tasks that are executed on the left side of T in the chain C and all parts of T or whole T in the right R-fragment are eliminated;

if some task T with splitting allowed is partially executed in the left and partially in the right fragments, then the duplicate executing parts of T may be eliminated in any way;

if some task T with splitting forbidden is executed in both left and right fragments and the duration of T in the intermediate schedule exceeds the original value, then the duration of the task T may be decreased to the original value by eliminating the continuous parts from the left or right end of T in any way.

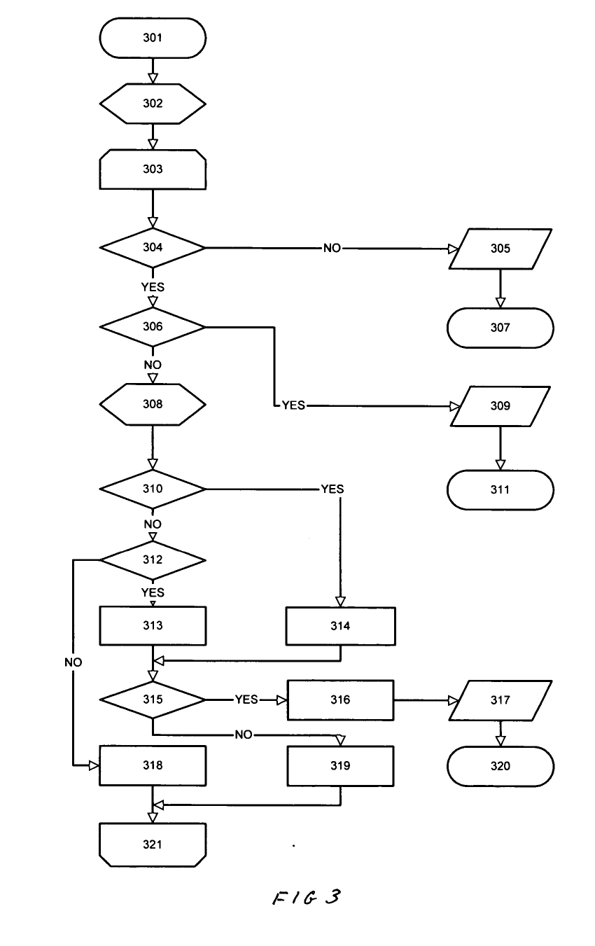

Current and the following paragraphs up to [0062] inclusive explain flowchart in FIG. 3 that details the block 220. Assumptions for the proposed solution: the project does not contain tasks with a given volume; coordinates are integer numbers; all task parts executed in some period are one-period-long; schedule vectors are vectors (1-coordinate, 2-coordinate . . . n-coordinate) where n—number of chosen chains; and the method of assigning coordinates is sequential ascending.

Start of a definition. A “shift right step” processes the set of schedule vectors. It replaces old values of coordinates in every schedule vector from said set with the new values: if an old value represents the idle period after the last task in a chain, then it stays unchanged; if an old value represents executing the last part of the last task in a chain, then the new value represents the idle period after the last task in the same chain; otherwise the new value represents executing the next to right one-period-long part of a task in the same chain. End of the definition. “Shift left step” is defined in the same way. Common name for both said steps is a “shift step”.

Step of searching for meeting schedule vectors comprises 2 steps. Step (b) is a shift right step applied to a list V of candidate schedule vectors built by the straight process for some period (218). Set of vectors U is result of step (b). Step (c) is searching for comparable vectors: vectors S and R are searched for such that S belongs to set U, R belongs to set W and the vector S is no less than the vector R (W—schedule vectors of the list of candidate schedule vectors built by the opposite process for some period). Step (c) is flowchart in FIG. 3 without blocks 316 and answer blocks. If said S and R are found, then the meeting schedule vectors are restored as prototype in V of the vector S and the vector R (316). In our demonstration the first found pair of meeting schedule vectors is taken without checking. In the case of usual constraints, check operations made in the straight and opposite processes are enough.

Two types of the divide-and-conquer method are used below. In “divide-and-conquer searching” method, not all sub instances of the problem instance must be solved; it is enough to find object(s) we are searching for. In “divide-and-conquer eliminating” method, after eliminating some object in one of the sub instances of problem, plurality of corresponded objects are eliminated in other sub instances.

FIG. 8 is the demonstration of the dividing scheme that may be used in different divide-and-conquer searching and divide-and-conquer eliminating methods that include searching for pair(s) (S, R) of vectors such that: S belongs to a given set U, R belongs to a given set W, and S is no less than R. In the example in FIG. 8 sets U and W consist of 3-dimensional vectors. For other dimensions, other number of vectors, and so on, method is analogous. Said sets are described as columns. U and W are sorted on the first component in the descending order. U is divided into subsets with the same value of the first component: A (value is 9), B (value is 7), and C (value is 4). The correspondent subset of W is chosen for every of said subsets of U. For subset X of U the principle is: the correspondent subset Y of W consists of vectors with value of 1-component that does not exceed value of the first component of vectors of X. So, W corresponds to A, E corresponds to B, G corresponds to C. Original instance of problem with sets U and W of 3-dimensional vectors is replaced by 3 sub instances with sets: A and W, B and E, C and G. All vectors in said sub instances are replaced by the 2-dimensional sub vectors, because the first component must not to be compared and may be deleted.

Designations of [0055] are saved for all sub instances of problem: the sets of vectors are called U and W, the vectors are searching for are called S and R.

FIG. 3 is a flowchart of the step of searching for meeting schedule vectors (block 220). A divide-and-conquer searching method is used. Sort operations are not indicated in the flowchart, they may be performed where it is appropriate. 301 is a start of the flowchart. 302 is preparing an initial list of sub instances. It contains one initial instance of the problem of searching for a pair of comparable vectors. 303-321 is a loop on the list of sub instances. 304 is the question: “Is at least one sub instance in the list?” 307 is “negative end”—meeting schedule vectors do not found. 305 is answer in machine readable form. 306 is the question: “Are computational limitations (time, memory and so on) met?” 311 is a “bad end”. 309 is appropriate message and statistics in machine readable form. 308 is selecting and preparation a sub instance from the list. 310 is the question: “Have the vectors in the current sub instance dimension 2?” 312 is the question: “Is the current sub instance small enough to be solved without further dividing?” 313 is solving the current sub instance with obvious or some external method. 315 is the question: “Are the pair of vectors we are looking for found?” 316 is restoring the meeting schedule vectors that are prototypes of found vectors. 320 is a “good end”. 317 is an answer in machine readable form. 319 is deleting the current sub instance from the list. 318 is replacing current sub instance in the list by its sub instances as was demonstrated in the previous paragraph.

Start of a definition. Suppose H is a sequence of the vectors of the same dimension. “Bubble elimination” of minor vectors of H contains steps of checking neighboring non-eliminated vectors; if they are comparable, then vector that is no grater than another is eliminated. End of the definition. “Bubble elimination” of major vectors is defined in the same way. Elimination of a vector is physical deleting or saving in any form indication that said vector is eliminated. “Bubble elimination” step may be used for eliminating minor vectors in said set U and major vectors in said set W in blocks 302, 308, 314, and 318.

Start of a definition. A sequence H of 2-dimensional vectors is called “bi-directional unique sorted” if: every value may be found no more than in one vector of H as the first component, and no more than in one vector of H as the second component; sequence of the first components of the vectors of H, and sequence of the second components of the vectors of H are sorted in the opposite directions. End of the definition. Example of a bi-directional unique sorted sequence of 2-dimensional vectors: (9,4), (8,5), (6,6), (5,8), (1,9).

314 is solving the current sub instance if it contains the vectors of dimension 2. U and W are lexicographically sorting in the descending order, if they are not sorted yet. The first step is converting U and W into the bi-directional unique sorted sequences UU and WW applying bubble elimination. Applying to the sequence U eliminating process moves from the beginning to the end of U; minor vectors are eliminated. Applying to the sequence W eliminating process moves from the end to the beginning of W; major vectors are eliminated. The second step is the loop of comparing vectors from UU with vectors from WW. In every iteration of the loop, a vector from UU (UU-vector) is compared with a vector from WW (WW-vector). In the first iteration, UU-vector is the first vector of UU, WW-vector is the first vector of WW. If the first component of UU-vector is less than the first component of WW-vector, then the name “WW-vector” passes to the next vector in sequence WW. If the second component of UU-vector is less than the second component of WW-vector, then the name “UU-vector” passes to the next vector in sequence UU. The loop is completed, if pair of vectors we are looking for is found, or the loop comes to the end of UU or WW.

Here a base condition is described for a group of effectiveness criteria that may be used in the straight species. The suppositions: schedule vectors are vectors (1-coordinate, 2-coordinate . . . n-coordinate), where n—number of the chosen chains; and method of assigning coordinates is ascending sequential. Said base condition is: schedule vector R belongs to the current list of candidate schedule vectors and is no greater than some generated schedule vector S. For the opposite species “no grater” is replaced by “no less”. On the some additional conditions R may be classified as unnecessary. Example of said additional conditions: S and R do not contain idle periods and contain one-period-long parts of the same tasks.

FIG. 4 is a flowchart of step of eliminating unnecessary schedule vectors based on the effectiveness criteria of group described in the previous paragraph. FIG. 4 is an optional part of block 126. A divide-and-conquer eliminating method is used here. After finding some unnecessary schedule vector, corresponding vectors are eliminated from plurality of sub instances. 401 and 402 are analogous to 301 and 302, respectively. 403-415 is a loop on the list of sub instances. 404, 406, and 408 are analogous to 304, 306, and 308, respectively. 407 is a “good end”-job is finished. 411 is a “forced end”. Statistics and answer are returned to called program in machine readable form (405 and 409). 410 is the question: “Is the current sub instance of problem small enough to be solved without further dividing?” 412 contains: solving current sub instance; restoring schedule vectors that are prototypes of found vectors; computing effectiveness criteria; and eliminating unnecessary schedule vectors and correspondent vectors in other sub instances. 414 is deleting current sub instance from the list. 413 is replacing current sub instance in the list by its sub instances as is demonstrated in [0057].

Start of a definition. A method of assigning schedule coordinates is called a “mixed method of assigning schedule coordinates”, if calculating coordinates includes adding numbers measured in different units (for example days and tons). End of the definition. Example of said method is assigning a coordinates to the states of some chain using the formula (a+b, c+d), where (all mentioned tasks belong to said chain): a is the duration of all the tasks with given duration completed before said period+the duration of the part of the uncompleted task with given duration (if exists) being executed before said period; b is calculated in the same way, but word “duration” is replaced by “volume”; c and d are calculated in the same way as a and b, respectively, but word “before” is replaced by “after”.

Start of a definition. A method of assigning schedule coordinates is called a “task-part-idle method”, if: 1. All combinations that participate in relationship are single states of the chains; said chains do not contain the tasks with given volume; 2. Coordinates are pairs of numbers. 3. The first number in said pair identifies a task; the second number in said pair identifies an executed part of said task or an idle period before or after said task in the chain said task belongs to. End of the definition.

Here is an estimation of the size of projects solvable by described in [0028]-[0045] straight species of invented method. For simplicity we take the project with the tasks with given duration; splitting is forbidden for all the tasks. Number of different schedule vectors does not exceed T 1*T 2* . . . *T n, where n—number of chosen chains, T i—number of coordinates assigned to the chain i. T i for the tasks with splitting forbidden is no more than T+(number of the tasks in chain i), where T—duration of resulting schedule, measured in periods. For project with 7 chains, T<=90, number of tasks in every chain<=10 we have (90+10)**7=10**14 different schedule vectors. Every schedule vector consists of 7 integer numbers (even, seems, 1-byte integer numbers) to be processed. For today's computers it is possible to carry such weight. For project with splitting allowed for all tasks, estimation is 6 chains instead of 7. Upper estimation we made is much more than real amount of calculations. Also, taking in account that: computer clusters or specialized devices may be used, the power of computers is increasing, and effectiveness criteria may be used, predicted size of projects solvable by invented method is: 6-10 chains, 10-20 tasks in chain, 100-200 period long schedules.

The invented method contains groups of alternative elements, optional elements, and references to external methods. The best combination of elements and external methods depends on: given constraints, a level of optimization required—optimal or feasible schedule, equipment used, advantage of some elements found during development or usage time. Choice may be done: during development time—some possibilities may be not implemented; during purchase time as options; at usage time—choice explicitly made by user; at usage time—the choice made automatically.

Examples of reasons for a best mode choice: using rough effectiveness criteria leads to the non optimal schedule; building a task reference construction saves calculations, but require additional memory.

Example of project for which invented method results in an optimal schedule: project without tasks with given volume; all durations are integer (unit of time is period); constraints are only of precedence, date and resource type; constraints for available resources are constant level only; rough effectiveness criteria are not used; “straight” species is used; all successors are built in every list of candidate schedule vectors. The example is true also for some criteria different from the shortest schedule.

The invented method may naturally be divided into several threads that run simultaneously. Thus a multiprocessor computer or computer cluster may be use Example: generating schedule vectors may be divided into parallel threads. Some operations may be performed as vector operations, for example comparing two vectors.

Specialized electronic devices may be used for invented method implementation alongside with computers or instead of them.

The invented method contains groups of alternative elements, optional elements, and references to external methods. Specific combination of disclosed elements may be chosen by developer or user. All such combinations are covered by claims of present invention (of cause, except of original external methods).

All details of method, described in the current section, are not intended to further limiting of the method as it is disclosed in claims. Rather they give illustration of preferred embodiment and may be modified or improved in development process accordingly to spirit and scope of the present invention.

What is claimed is:

1. A method of scheduling a project consisting of related tasks, said method comprising the step of generating a coordinate reference construction.

2. The method of claim 1 wherein said step of generating a coordinate reference construction includes generating schedule coordinates using a sequential method of assigning schedule coordinates.

3. The method of claim 1 wherein said step of generating a coordinate reference construction includes generating schedule coordinates using a task-part-idle method of assigning schedule coordinates.

4. The method of claim 1 wherein said step of generating a coordinate reference construction includes generating schedule coordinates using a mixed method of assigning schedule coordinates.

5. The method of claim 1 wherein said project is manufacturing or maintenance of not big number of objects.

6. A method of scheduling a project consisting of related tasks, said method comprising the step of generating, checking and eliminating schedule vectors.

7. The method of claim 6, wherein generated schedule vectors have the structure: (1-coordinate, 2-coordinate . . . n-coordinate) where n—number of chosen chains.

8. The method of claim 6 wherein said step of generating, checking and eliminating schedule vectors comprises at least one step of computing effectiveness criteria and eliminating unnecessary schedule vectors; at least one effectiveness criterion is computed by every step of computing effectiveness criteria and eliminating unnecessary schedule vectors.

9. The method of claim 8, wherein the at least one step (a) of computing effectiveness criteria and eliminating unnecessary schedule vectors comprises computing at least one effectiveness criterion including comparing of two or more generated schedule vectors.

10. The method of claim 9, wherein step (a) further comprises at least one step of selecting a group of equivalent generated schedule vectors.

11. The method of claim 9, wherein step (a) uses divide-and-conquer eliminating method; in said divide-and-conquer eliminating method:
selecting vectors of an instance for including in at least one of its sub instances is based on belonging components of the vectors of the instance to one or more intervals; and
the dimension of the vectors of an instance is grater than the dimension of the vectors in at least one of its sub instances; the definition of the dimension of a vector here is “the number of its components”.

12. The method of claim 6 wherein said step of generating, checking and eliminating schedule vectors comprises at least one loop of generating schedule vectors such that:
schedule vectors generated in the same iteration of the loop are candidates for the same period;
the candidate schedule vectors generated in any non first iteration of the loop are the children of the candidate schedule vectors generated in the previous iteration of the loop.

13. The method of claim 6 wherein said step of generating, checking and eliminating schedule vectors comprises at least one step of searching for meeting schedule vectors.

14. The method of claim 13 wherein the at least one step of searching for meeting schedule vectors comprises:
(b) shift step;
(c) step of searching for comparable vectors.

15. The method of claim 14 wherein step (c) using divide-and-conquer searching method; in said divide-and-conquer searching method:
selecting vectors of an instance for including in at least one of its sub instances is based on belonging components of the vectors of the instance to one or more intervals; and
the dimension of the vectors of an instance is grater than the dimension of the vectors in at least one of its sub instances; the definition of the dimension of a vector here is “the number of its components”.

16. The method of claim 15 wherein said step (c) using a divide-and-conquer searching method further includes steps of bubble elimination.

17. The method of claim 15 wherein said step (c) using a divide-and-conquer searching method further includes:
the steps of generating a bi-directional unique sorted sequence of vectors; and
the steps of comparing vectors of a bi-directional unique sorted sequence with vectors of another bi-directional unique sorted sequence.

18. The method of claim 6 additionally comprising the step of eliminating duplicate parts of tasks.

19. The method of claim 6 additionally comprising the step of generating a task reference construction.

20. The method of claim 6 wherein said project is manufacturing or maintenance of not big number of objects.
